(19) United States
(12) Patent Application Publication
(10) Pub. No.: US 2025/0214737 A1
(43) Pub. Date: Jul. 3, 2025

(54) Labelling module for applying labels obtained from a web of labelling material onto articles adapted to contain a pourable product

(71) Applicant: SIDEL PARTICIPATIONS, OCTEVILLE-SUR-MER (FR)

(72) Inventors: Nicola FACCHINI, Mantova (IT); Salman AYUB, Mantova (IT); Nicolas CHOMEL, Octeville-sur-mer (FR); Cristian ANDREATO, Mantova (IT)

(21) Appl. No.: 18/833,433

(22) PCT Filed: Dec. 2, 2022
(86) PCT No.: PCT/EP2022/084276

§ 371 Date: Jul. 26, 2024

(30) Foreign Application Priority Data
Feb. 1, 2022 (EP) EP22154430.7

(51) Int. Cl. B65C 9/18; B26D 1/143

(52) U.S. Cl. CPC B65C 9/1819; B26D 1/143; B65C 2009/1838

(57) ABSTRACT

A labelling module for applying labels that are obtained from a web of labelling material and onto articles adapted to contain a pourable product. In example embodiments, the labelling module includes a feed system, a cutting unit, a cutting station, and a transfer device. In example embodiments, the feed system is configured for feeding the web along a feed path, the cutting unit is configured for repeatedly cutting the web at a cutting station arranged along the feed path, thereby obtaining a sequence of labels. And the transfer device is configured for receiving the sequence of labels and for transferring them to an application station for the application thereof onto the respective articles.

### TECHNICAL FIELD

The present invention relates to a labelling module for applying labels obtained from a web of labelling material onto articles, such as bottles, flacons or containers of this sort, adapted to contain a pourable product, preferably a pourable food product.

### BACKGROUND ART

Labelling machines are known, which are commonly used to prepare, transport and apply labels onto articles, such as bottles, flacons or containers of this sort, destined to be filled with a pourable product, in particular a pourable food product.

Particularly widespread is the use of glued labels, i.e. portions of a labelling material that are cut at appropriate lengths from a web of labelling material initially wound around one or more storage reels and then sprinkled with glue.

In detail, the web of labelling material is progressively unwound off the relative reel and then sequentially cut to obtain successive labels of equal length, upon which glue is applied by gluing means, such as a gluing roller, spray or injector systems or the like.

Eventually, the labels so obtained are conveyed and applied onto the respective articles to be labelled.

Particularly widespread are also labels of the tubular kind, known as “sleeve labels” and obtained starting from a web of heat-shrinking film wound around one or more storage reels; the sleeve labels are applied with a certain clearance on the respective articles and then heated in an oven to obtain their shrinking and perfect adhesion to the lateral surfaces of the articles themselves. These types of labels do not require the use of glue.

Regardless of the type of label used, a known labelling machine typically comprises:
a carousel rotatable around a vertical axis and configured to convey a plurality of articles along an horizontal, arc-shaped transfer path;
an inlet station, at which the articles to be labelled are received by the carousel;
an outlet station, at which the labelled articles exit the carousel; and
a labelling module, peripherally arranged relatively to the carousel and configured to prepare, transport and feed a plurality of labels to the carousel at an application station, in order to apply such labels to respective articles.

According to a well-known configuration, a labelling module typically comprises:
one or more storage units, for example reels or spools around which the web of labelling material is initially wound;
a plurality of unwinding rollers, which support, in use, the web progressively unwound from the reel and guide it, in use, along a feeding path;
a cutting unit for repeatedly cut the web at a cutting station so as to separate a sequence of labels from the web itself; and
a label transfer device, for example a known vacuum drum configured to receive, retain and advance each label and to feed each label to the carousel, at the application station.

In particular, the vacuum drum is configured to receive the labels, to retain them by means of suction and, after a rotation by a determined angle about its axis, to release these labels to the application station, so that they are applied onto the respective articles advanced by the carousel.

Furthermore, in the case of labels that provide for the use of glue, the labelling module comprises at least one gluing roller arranged substantially tangent to the vacuum drum, in a position operatively downstream of the cutting unit and upstream of the application station, for spreading glue onto at least the (leading and trailing) ends of each single label, prior to their application onto the relative articles.

In another known solution, gluing means comprise a spray nozzle arranged peripherally to the vacuum drum.

According to a well-known configuration, rotary-type cutting units are used, which comprise:
a first rotary member, usually a blade support roller (or “blade roller”), rotatably mounted about a typically vertical axis, carrying a first cutting element, such as a blade or a knife, and configured to convey the blade along a circular cutting path around the above-mentioned axis; and
a second rotary member, usually a counter-roller carrying a second cutting element, normally a counterblade element for the blade (“counterblade roller”), rotatably mounted about an axis usually parallel to the axis of the first rotary member, arranged peripherally to the first rotary member, so as to be substantially tangent to the cutting path, and configured to support the web of labelling material and convey it towards the cutting station, at which the web is cut by interaction of the blade with the counterblade element.

Typically, the second rotary member defines an abutment surface for the blade and also a support roller for the web to be cut by the blade and for the web to be advanced along the feeding path, towards the vacuum drum.

To this end, in some known embodiments, the counterblade roller is provided with dedicated vacuum ports substantially similar to the vacuum ports of the vacuum drum and configured to apply vacuum to the web of labelling material supported thereon, so as to support the web and advance the newly cut labels towards the vacuum drum.

In use, by mutual rotation of the blade roller and the counterblade roller, the blade and the counterblade element are cyclically carried simultaneously at the cutting station, at which they cooperate with one another for cutting the web.

In practice, the web is interposed, in use and at the cutting station, between the blade roller and the counterblade roller, namely between the blade and the counterblade element, the latter sequentially acting as an abutment element for the blade during the cutting.

It is known in the field a wear of the blade due to the repetitive interaction with the aforementioned abutment surface.

According to a known solution, the counterblade element is provided as a radial recess or slot obtained on the peripheral surface of the counterblade roller.

It is further known in the field to provide a temporary sliding of the free end flap or portion of the web of labelling material not yet cut on the vacuum drum, namely the sliding or slipping of the leading end of each label on the vacuum drum, when the label is still attached to the web.

In other words, it is known a sliding of the free end flap of the web as soon as it is grasped by the vacuum action of the vacuum drum, i.e. when the label is still attached to the web of labelling material at its trailing end portion and has not yet been cut by the cutting unit.

This sliding is due to the fact that the web and the vacuum drum have different peripheral speeds, in particular the web is slower than the vacuum drum.

This is necessary in order to obtain a pitch of the labels transferred by the vacuum drum which matches the pitch of the articles advanced by the carousel.

In other words, it is necessary to space the labels apart from one another, which are initially attached in succession to one another forming the web, so as to match the pitch of the articles advanced by the carousel.

Although the labelling modules of the type described above are functionally and structurally valid, the Applicant has observed that they are still open to further improvements.

In particular, the Applicant has observed that the sliding of the free end flap of the web of labelling material on the vacuum drum entails some disadvantages, such as:
difficulty in managing the vacuum system, as it is necessary to manage both the retaining of the label on the vacuum drum and the delivery of the label from the counterblade roller to the vacuum drum;
an inaccurate positioning of the label on the vacuum drum after it has been delivered by the counterblade roller, due to the sliding;
a complicated management of the kinematics between the counterblade roller and the vacuum drum in order to obtain the above-mentioned sliding on the vacuum drum;
complications from a process cleanliness perspective, as the sliding of the labels on the vacuum drum leads, in the long run, to residual accumulations of glue that can compromise the correct feeding of the labels to the articles.

It is therefore desirable to limit or avoid the sliding of the web on the vacuum drum, without however compromising the quality of the cut.

### DISCLOSURE OF INVENTION

It is therefore an object of the present invention to provide a labelling module which is designed to overcome at least one of the above-mentioned drawbacks in a straightforward and low-cost manner.

This object is achieved by a labelling module as claimed in claim 1.

### BRIEF DESCRIPTION OF THE DRAWINGS

A non-limiting embodiment of the present invention will be described by way of example with reference to the accompanying drawings, in which:

FIG. 1 is a schematic top view, with parts removed for clarity, of a labelling machine including a labelling module according to the present invention; and

FIGS. 2 to 5 are larger-scale, schematic top views, with parts removed for clarity, of a cutting unit of the labelling module of FIG. 1, during respective distinct operative conditions.

### BEST MODE FOR CARRYING OUT THE INVENTION

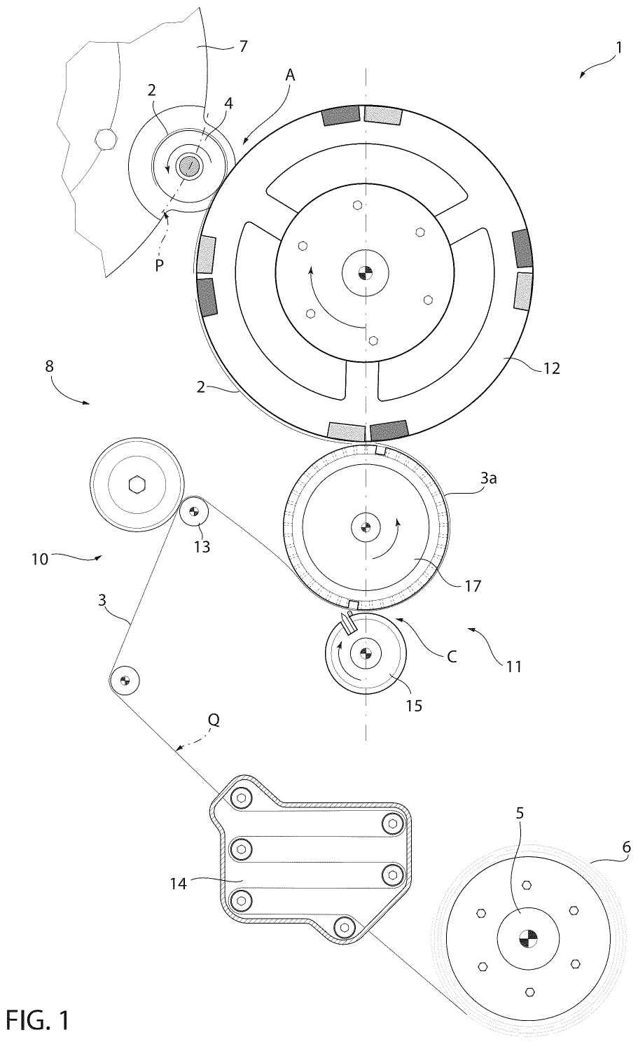

With reference to FIG. 1, number 1 indicates as a whole a labelling machine for applying labels 2 obtained from a web 3 of labelling material onto articles 4, such as (glass or plastic) bottles, flacons, cans, or containers of this sort, adapted to contain a pourable product, preferably a pourable food product.

In detail, labelling machine 1 is configured to prepare, transport and apply a sequence of labels 2 onto articles 4.

According to this preferred and non-limiting embodiment, labels 2 are glued labels, i.e. strips of labelling material that are cut at predetermined lengths from web 3 and then sprinkled with glue (for example by a glue roller, which is well-known and not shown in detail).

Alternatively, labels 2 can be of the aforementioned “sleeve labels” type.

Preferably, web 3 of labelling material is initially wound around one or more spools 5 in the form of a reel 6, and is progressively unwound, in use, off reel 6.

As visible in FIG. 1, labelling machine 1 essentially comprises:
a conveyor device, preferably a rotary carousel 7 rotatable around a fixed axis (not shown), in particular vertical, and configured to advance a plurality of articles 4 (only one of which is shown) along a labelling path P, in the example shown an arc-shaped, horizontal path;
an inlet station (not shown), at which articles 4 to be labelled are fed to carousel 7;
an outlet station (not shown), at which labelled articles 4 exit from carousel 7; and
a labelling module 8 (only partially and schematically general shown), arranged peripherally relatively to carousel 7 and configured to prepare and feed a plurality of labels 2 to the carousel 7 itself at an application station A, in order to apply labels 2 onto respective articles 4.

In detail, labelling module 8 comprises:
at least one aforementioned spool 5 for rotatably supporting a reel 6 of web 3;
a plurality of unwinding rollers 10, which support, in use, the web 3 progressively unwound from the reel 6 and guide it along a feed path Q, thereby defining a feed system;
a cutting unit 11 for repeatedly cutting the web 3 at a cutting station C arranged along the feed path Q, thereby obtaining a sequence of labels 2 therefrom; and
a transfer device 12 for receiving the sequence of labels 2 and for transferring them to the application station A for the application thereof onto the respective articles 4.

In particular, feed system 10 comprises a feed roller 13, preferably motorized, which is configured to advance the web 3 along the feed path Q with a predetermined feeding speed, thereby causing the unwinding of the web 3 itself from the reel 6.

More precisely, the feed path Q stretches from the reel 6 up to the application station A. In other words, the feed path Q is a path along which the web 3 is advanced, prior to the cutting, and then along which the labels 2 are advanced, after the cutting.

Hence, the cutting station C is arranged along the feed path Q, in correspondence with the cutting unit 11.

Preferably, the transfer device includes a transfer drum, in particular a known vacuum drum 12 rotatable about a central axis, preferably vertical, and configured for retaining the labels 2 by means of suction applied through known vacuum ports (not shown) which are selectively connectable to a known vacuum source. In use, after a rotation of a certain angle about its axis, the vacuum drum 12 releases the retained labels 2 at the application station A, so that such labels 2 can be applied onto respective articles 4 advanced by the carousel 7.

Conveniently, labelling module 8 further comprises:
a gluing unit, for example a gluing roller (not shown) for sprinkling the labels 2 with glue while they are transferred by the vacuum drum 12, upstream of application station A; and
a buffer device 14 for temporarily accumulating a length of web 3.

According to the preferred embodiment shown, cutting unit 11 is of the rotary type and comprises a first roller 15 carrying at least one first cutting element 16 at a lateral surface 15a thereof, and a second roller 17 carrying at least one second cutting element 18 at a lateral surface 17a thereof.

In particular, the first roller 15 defines a blade roller carrying a blade member 16 defining, in turn, the first cutting element, and the second roller 17 defines a counterblade roller carrying a counterblade member 18 defining, in turn, the second cutting element.

More in particular:
the first roller 15 is rotatable about a first axis X, preferably vertical, radially carries the blade member 16 so that this latter protrudes from its lateral surface 15a, and is configured to convey the blade member 16 along a circular cutting path around axis X;
the second roller 17 is rotatable about a second axis Y, is arranged peripherally adjacent to the first roller 15 (so as to be substantially tangent to the cutting path), radially carries the counterblade element 18, and is configured to support the web 3 on its lateral surface 17a, and convey it towards the cutting station C, at which the web 3 is cut by interaction of the blade member 16 with the counterblade member 18.

Preferably, the second roller 17 is provided with vacuum ports to better grasp the web 3.

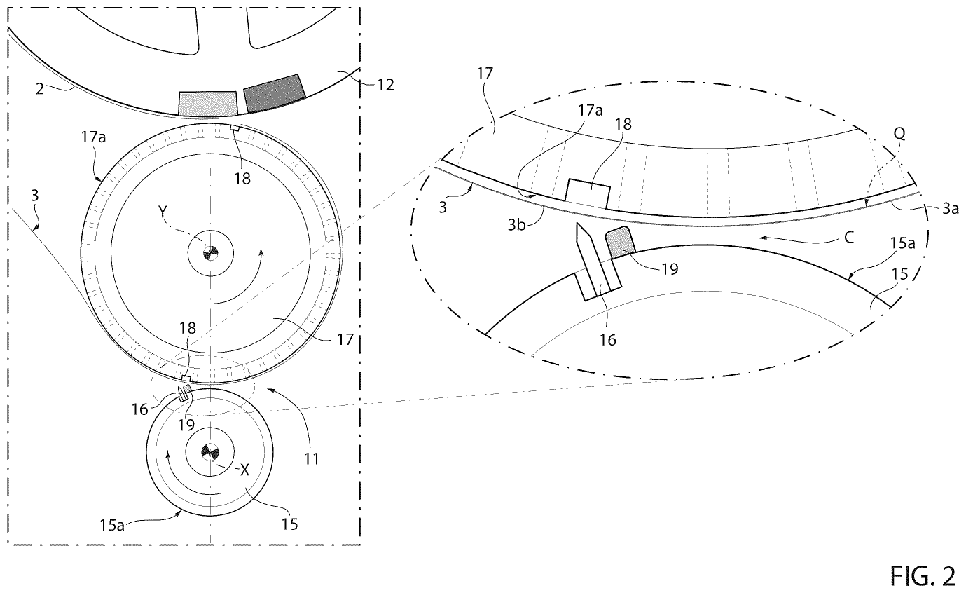

As visible in detail in FIGS. 2 to 5, the cutting station C is arranged between the lateral surfaces 15a and 17a, i.e. between the first roller 15 and second roller 17.

In practice, the web 3 is interposed, in use and at the cutting station C, between the first roller 15 and the second roller 17; namely, the first roller 15 and the second roller 17 are arranged at opposite (lateral) sides of the feed path Q, and therefore of the web 3 and of the cutting station C, so that the blade member 16 and the counterblade member 18 are cyclically positioned at opposite sides of the web 3 when conveyed at the cutting station C.

Accordingly, the first roller 15 and the second roller 17 are rotatable, respectively about axes X and Y, for cyclically conveying the blade member 16 and the counterblade e member at 18 the cutting station C simultaneously for cyclically interacting or cooperate with one another and with the web 3 thereat to perform the repeated cutting of the web 3 itself.

Conveniently, the counterblade member is defined by, i.e. is provided as, a recess or slot 18 obtained on the lateral surface 17a.

Preferably, the second roller 17 has two slots 18, arranged at 180° from one another, relative to axis Y.

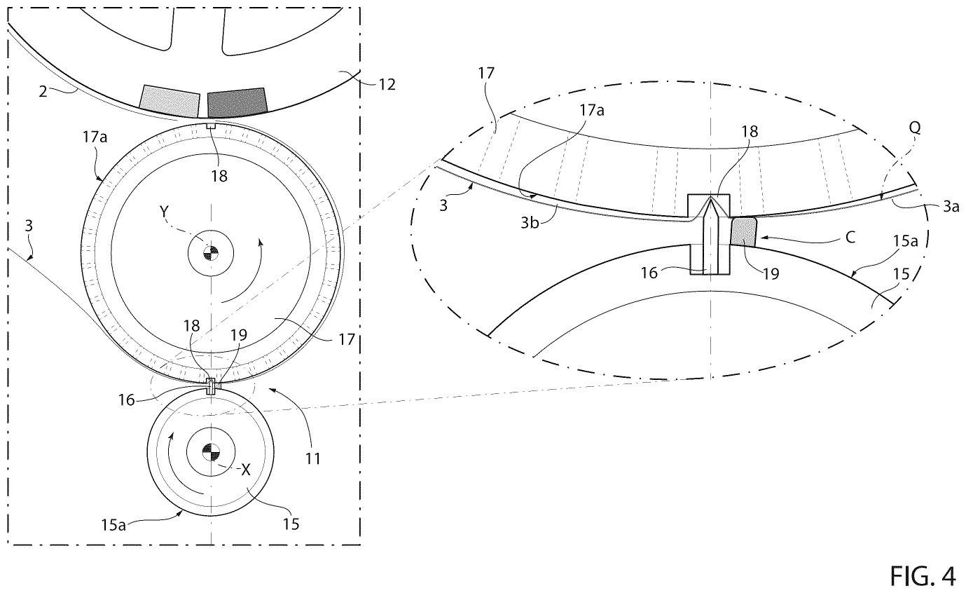

As shown in FIGS. 2 to 5, and particularly in FIG. 4, the blade member 16 is configured to cyclically engage the slot 18 at the cutting station C, by means of the mutual rotation of the first roller 15 and second roller 17, to perform the cutting of web 3.

More precisely, the blade member 16 engages the slot without abutting against the back wall of the slot 18, thereby defining a “cut in slot”.

In this way, a wear of the blade member 16 and of the second roller 17 is reduced.

However, in certain cases, such “cut in slot” determines a movement of the web 3 along the feed path Q during cutting.

More precisely, in use, when the blade member 16 engages the slot 18 the web 3 can be pulled towards the slot 18 itself by the pressing action of the blade member 16.

This could lead to a non-nominal cut, to difficulties in cutting, and to a mispositioning of the resulting label 2 onto the lateral surface 17a and, subsequently, onto the vacuum drum 12.

According to an aspect of the present invention, the cutting unit 11 comprises a stopping member 19 carried by one of the first roller 15 and second roller 17 and configured to cyclically interact with the web 3 during the cutting thereof at a position which is, along the feed path Q and/or according to the feeding direction, exclusively downstream of the cutting station C, for temporarily blocking a movement of the web 3 along the feed path Q.

In particular, the stopping member 19 is configured to cyclically interact with the web 3 to temporarily block a movement along the feed path Q of a portion 3a of the web 3 which during cutting thereof is cyclically arranged downstream of the cutting station C, relative to the feed path Q.

In other words, the stopping member 19 interacts, in use, with said portion 3a to stop a movement thereof along the feeding path Q, during cutting of the web 3, i.e. during engagement of the slot 18 by the blade member 16 at the cutting station C, cyclically. Conveniently, the stopping member 19 is carried by the first roller 15 at the lateral surface 15a thereof.

More in particular, the stopping member comprises, preferably is defined by, a presser element 19 which radially protrudes from the lateral surface 15a and which is configured for cyclically pressing the web 3 against the second roller 17, i.e. against the lateral surface 17a of the latter, in a position exclusively downstream of the cutting station C, relative to the feed path Q, so as to temporarily block any movement of said portion 3a along the feed path Q itself.

Advantageously, the presser element 19 is carried by the first roller 15 in a position adjacent of the blade member 16.

In detail, the presser element 19 is arranged, on the lateral surface 15a, in a position exclusively downstream of the blade member 16, relative to a direction of rotation of the first roller 15 about its axis X.

In greater detail, the presser element 19 is arranged substantially immediately downstream of the blade member 16, as visible in the appended Figures.

In other words, the presser element 19 is positioned exclusively downstream of the blade member 16, relative to an advancement direction of the web 3 along the feed path Q, said advancement direction stretching from the reel 6 up to the application station A and passing through the cutting station C.

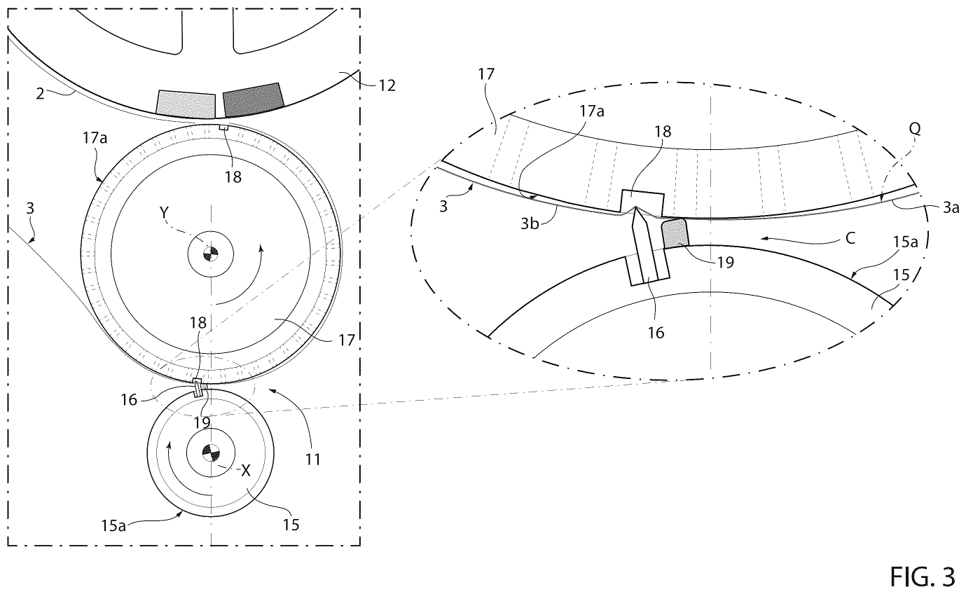

As visible in particular in FIGS. 3 and 4, the presser element 19 is configured to interact with the web 3, in particular with portion 3a of web 3, at least during engaging of the slot 18 by the blade member 16.

Thanks to the above configuration, a movement of the web 3, and in particular of the portion 3a of the web which is downstream of the cutting station C, towards and inside the slot 18 is avoided, without however hindering a movement of the portion 3b of the web 3 which is upstream of the cutting station C, relative to the feed path Q. In fact, the presser element 19 blocks the portion 3a against the lateral surface 17a of the second roller 17, while leaving the portion 3b free (FIG. 4) of moving.

This entails two synergic technical effects:
a tensioning of the web 3 downstream of the cutting station C is produced, which avoids that the web 3 is pulled into the slot 18 during cutting and at the same time provides a facilitated breakage and an improved, cleaner cut of the web 3;
a (cyclical) sliding of the web 3 on the second roller 17, instead of on the vacuum drum 12, can be provided without sacrificing the quality of the cut.

Accordingly, the second roller 17, which is configured to support the web 3 on its lateral surface 17a, is advantageously configured to be rotated at a rotational speed defining a support linear speed greater than the aforementioned feeding speed of the feed roller 13, for causing a cyclical sliding of the web 3 on the lateral surface 17a of the second roller 17.

More specifically, since the linear speed of the second roller 17 is greater than the advancing speed of the web 3, defined by the feed roller 13, a cyclical sliding of the web 3 on the second roller 17 is obtained. Such sliding provides the aforementioned spacing of the labels 2 in order to match the pitch of the articles 4 carried by the carousel 7, without however incurring in the drawbacks cited above.

In other words, the presence of the presser element 19 exclusively downstream of the blade member 16 and its interaction with the web 3 (portion 3a) exclusively downstream of the cutting station C, allows to provide the sliding of the web 3 on the second roller 17, without the need for such sliding on the vacuum drum 12.

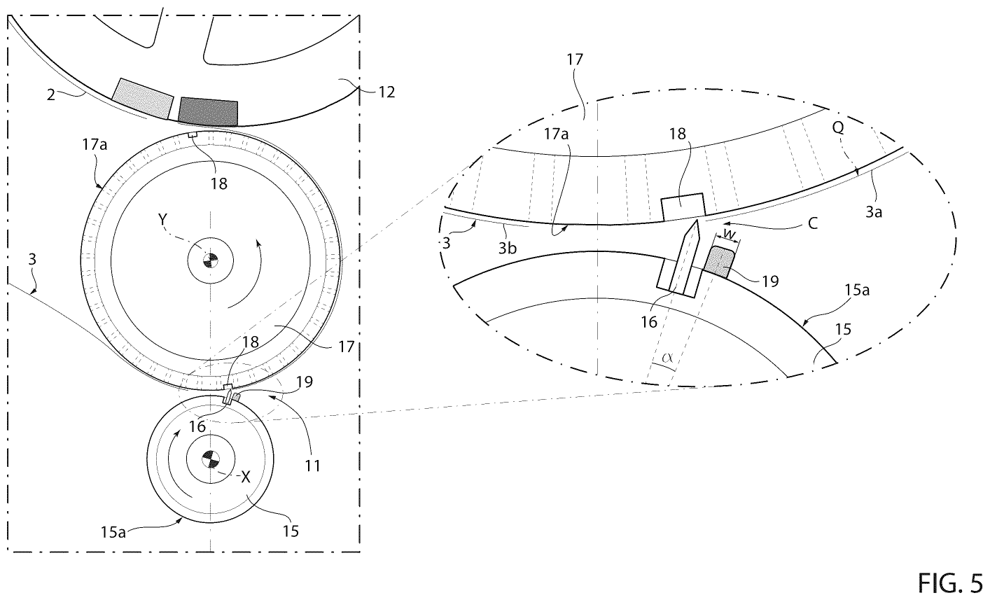

Such sliding is visible in FIG. 5, wherein it is schematically shown how, after cutting, the slot 18 is advancing faster than the portion 3b of web 3. On FIG. 5, it can be seen that the positioning of the presser element 19 only downstream of the cutting station C, prevents the presser element 19 to hinder the cyclical sliding of the web, thereby allowing to obtain simultaneously the advantage deriving from the cyclical sliding of the web on the second roller 17, and therefore from the reduction or elimination of the sliding on the vacuum drum 12, and the advantage deriving from the tensioning of the web during the cut by the presser element 19.

Accordingly, the vacuum drum 12 is advantageously configured to be rotated at a rotational speed defining a transfer linear speed which is equal to said support linear speed.

In this way, after each cutting of the web 3, the newly produced labels 2 are isokinetic with the second roller 17 and, most importantly, with the vacuum drum 12, so that no sliding of the labels 2 is defined on the vacuum drum 12 itself.

In light of the above, the labelling module 8 according to the present invention allows to improve the cutting precision and quality by means of the gripping action of the presser element 19, but without such gripping action opposing the sliding of the remaining portion 3b of the web 3 on the second roller 17 after the cutting has taken place.

Preferably, the presser element 19 is made of an elastomeric material, for example rubber.

In this way, a strong grip of the web 3 between the presser element 19 and the second roller 17 can be obtained, without however leading to a rapid wear of the components involved.

Conveniently, the presser element 19 is arranged at an angular distance from the blade member 16, relative to axis X, so that said blocking of the movement of the web 3 starts when the blade member 16 interacts with the web 3 and stops when such interaction ceases.

In other words, the presser element 19 is arranged at a (relatively short) angular distance from the blade member 16, relative to axis X, so that when the blade member 16 is located at the cutting station C also the presser element 19 is located at the cutting station C.

The value of an angular distance between the stopping member 19 and the first cutting element 16, relative to said first axis X, is less than 20°, or is less than 5°, or falls between 5° and 15°, or falls between 10° and 20°. Each of those angular distance ranges is particularly suitable for a respective range of radial dimension of the first roller 15, to ensure the correct working of the stopping member, and in particular to ensure that, for at least one of a plurality of possible relevant ranges of dimension of the first roller 15, said blocking of the movement of the web 3 starts just before or when the first cutting element 16 interacts with the web 3, and/or stops when the interaction of the first cutting element 16 with the web 3 ceases.

The value of a width of the stopping member, along an angular direction around said first axis X, is less than 0.005 m or less than 0.004 m, to have simultaneously a good gripping action without an excessive stretching of the web.

In FIG. 5, the angular distance is indicated with o and the width is indicated with w.

The Applicant has observed, by an extensive experimental campaign, that the above values allow to obtain an optimal configuration of the presser element 19 according to the invention.

According to an alternative embodiment not shown, the first roller 15 comprises a plurality of blade members 16, angularly distributed on the lateral surface 15a relative to axis X.

In such a case, the cutting unit 11 conveniently comprises a plurality of presser elements 19, each associated with one respective blade member 16.

More precisely, each presser element 19 is arranged adjacent to one respective blade member 16 and in a position exclusively downstream of the blade member 16, as explained above.

According to a preferred embodiment not shown, the presser element 19 is extractable from the lateral surface 15a for selectively pressing the web 3 against the lateral surface 17a.

This embodiment is particularly advantageous in the case in which the blade member 16 is also extractable/retractable from the lateral surface 15a.

The operation of the labelling module 8 is described hereinafter with reference to a single label 2 to be cut and starting from a condition in which the blade member 16 and the slot 1 are almost conveyed, simultaneously, at the cutting station C (FIG. 2).

In such condition, the web 3 is supported on the lateral surface 17a of the second roller 17 and is also sliding thereon, due to the aforementioned difference in speed of the second roller 17 and of the feed roller 13.

When the blade member 16 starts to interact with the web 3, the presser element 19 starts to press the portion 3a of the web against the lateral surface 17a, due to its peculiar positioning relative to the blade member 16, thereby tensioning portion 3a and blocking its movement along the feed path Q, resulting in a clean cut (FIG. 4).

Right after the label 2 is produced, the remaining part of the web 3, i.e. portion 3b, slides on second roller 17, since the presser element 19 is only present downstream of cutting station C and, therefore, does not hinder a movement of such portion 3b along the feed path Q, while the label 2 goes isokinetic with the second roller 17 and, after its transfer onto the vacuum drum 12, with this latter.

In practice, after the cut there could be an instant in which the portion 3b is free to move along the feed path Q while the portion 3a is still blocked by the presser element 19.

Thanks to the presser element 19 being positioned only downstream of the cutting station and/or of the blade member 16, with respect to the web advancement direction, it is possible to obtain both a clean cut and a sliding of the web 3 onto the second roller 17.

Then, label 2 is applied to the respective article 4 at the application station A.

The above operation is repeated cyclically for each label 2 to be produced and applied to articles 4.

The advantages of the labelling module 8 according to the present invention will be clear from the foregoing description.

In particular, thanks to the presence and particular configuration and positioning of the presser element 19, a sliding of the web 3 can be provided only on the second roller 17 and avoided on the vacuum drum 12, while maintaining, at best improving, the quality of the cutting.

Consequently, the position of the labels 2 on the vacuum drum 12 is improved, a complicated management of the kinematics, as well as the vacuums, between the second roller 17 and the vacuum drum 12 can be avoided, and the cleanliness and hygiene of the labelling process is generally improved, as the sliding of the web 3 does not affect any residual glue on the vacuum drum 12.

Furthermore, such advantages are reachable without sacrificing the quality and precision of the cutting.

Clearly, changes may be made to labelling module 8 as described herein without, however, departing from the scope of protection as defined in the accompanying claims.

In particular, the stopping member 19 could be carried by the second roller 17 in a position exclusively downstream of the slot 18. In this case, the stopping member could be defined by a vacuum port or another means to temporarily grasp the web 3 and block its movement along the feed path Q.

1. Labelling module for applying labels obtained from a web of labelling material onto articles adapted to contain a pourable product, the labelling module comprising:
a feed system for feeding the web along a feed path;
a cutting unit for cyclically cutting the web at a cutting station arranged along the feed path, thereby obtaining a sequence of labels; and
a transfer device for receiving the sequence of labels from the cutting unit, and for transferring them to an application station, to apply the labels onto respective articles;
wherein the cutting unit comprises a first roller carrying at least one first cutting element at a lateral surface thereof, and a second roller carrying at least one second cutting element at a lateral surface thereof,
the cutting station being arranged between the lateral surfaces of the first roller and of the second roller,
the first roller and the second roller being rotatable for cyclically conveying simultaneously the first cutting element and the second cutting element at the cutting station, to perform the cyclical cutting of the web by means of cyclical cooperation between the first cutting element and the second cutting element;
and wherein the cutting unit comprises a stopping member carried by one of said first roller and second roller, and configured to cyclically interact with the web during the cutting thereof at a position which is, along the feed path and according to the web feeding direction, exclusively downstream of the cutting station, for temporarily blocking a movement of the web along the feed path;
wherein the feed system comprises a feed roller configured for advancing the web along the feed path with a predetermined feeding speed;
wherein the second roller is configured to support the web on its lateral surface and to be rotated at a rotational speed defining a web support linear speed which is greater than said feeding speed, to cause a cyclical sliding of the web on the lateral surface of the second roller;
wherein the transfer device comprises a vacuum drum configured for receiving the cut labels from the cutting unit, for spacing the received labels from one another and for applying the spaced labels onto the articles at the application station,
and wherein the vacuum drum is configured to be rotated at a rotational speed defining a transfer linear speed which is greater than said feeding speed and/or equal to said support linear speed.

2. Labelling module as claimed in claim 1, wherein the stopping member is configured to cyclically interact with the web to temporarily block a movement along the feed path of a portion of the web which during cutting thereof is cyclically arranged downstream of the cutting station, according to the feeding direction and relative to the feed path.

3. Labelling module as claimed in claim 1, wherein the stopping member is arranged at the lateral surface of said one of said first roller and second roller and in a position which is exclusively downstream of its first cutting element or second cutting element, respectively.

4. Labelling module as claimed in claim 3, wherein the first cutting element comprises a blade member and the second cutting element comprises a counterblade member;
wherein the first roller is rotatable about a first axis to cyclically convey the blade member at the cutting station;
and wherein the stopping member is carried by the first roller at the lateral surface thereof and in a position exclusively downstream of the blade member, relative to a direction of rotation of the first roller about the first axis.

5. Labelling module as claimed in claim 4, wherein the stopping member is positioned exclusively downstream of the blade member, relative to an advancement direction of the web along the feed path.

6. Labelling module as claimed in claim 4, wherein the stopping member comprises a presser element which radially protrudes from the lateral surface of the first roller and which is configured for cyclically pressing the web against the second roller in a position exclusively downstream of the cutting station, relative to the feed path, to temporarily block the movement along the feed path of a portion of the web which during cutting thereof is cyclically arranged downstream of the cutting station.

7. Labelling module as claimed in claim 4, wherein the second roller is rotatable about a second axis, the first roller and the second roller being arranged adjacent to one another and at opposite sides of the feed path and of the cutting station, so that the blade member and the counterblade member are cyclically positioned at opposite sides of the web when conveyed at the cutting station.

8. Labelling module as claimed in claim 4, wherein the second roller is further configured to support the web on its lateral surface;
wherein the counterblade member is defined by a recess or slot obtained on the lateral surface of the second roller;
wherein the blade member is configured to cyclically engage the slot at the cutting station, by means of mutual rotation of the first roller and second roller, to perform the cutting of the web;
and wherein the stopping member is configured to interact with the web at least during engaging of the slot by the blade member.

9. Labelling module as claimed in claim 1, wherein the first roller is rotatable about a first axis for cyclically conveying the first cutting element at the cutting station,
wherein the stopping member is carried by the first roller at the lateral surface thereof,
and wherein the stopping member is arranged at an angular distance from the first cutting element, relative to said first axis, so that said blocking of the movement of the web starts just before or when the first cutting element interacts with the web and/or stops when the interaction of the first cutting element with the web ceases.

10. Labelling module as claimed in claim 1, wherein the first roller is rotatable about a first axis for cyclically conveying the first cutting element at the cutting station,
wherein the stopping member is carried by the first roller at the lateral surface thereof,
and wherein the stopping member is arranged at an angular distance from the first cutting element, relative to said first axis, so that when the first cutting element is located at the cutting station also the stopping member is located at the cutting station.

11. Labelling module as claimed in claim 10, wherein the first roller is rotatable about a first axis for cyclically conveying the first cutting element at the cutting station,
wherein the stopping member is carried by the first roller at the lateral surface thereof,
and wherein the value of an angular distance between the stopping member and the first cutting element, relative to said first axis, is less than 20°, or is less than 5°, or falls between 5° and 15°, or falls between 10° and 20°.

12. Labelling module as claimed in claim 11, wherein the first roller is rotatable about a first axis for cyclically conveying the first cutting element at the cutting station,
wherein the stopping member is carried by the first roller at the lateral surface thereof,
and wherein a width of the stopping member, along an angular direction around said first axis, is less than 0.005 m or less than 0.004 m.

13. Labelling module as claimed in claim 1, wherein the stopping member is carried by the first roller at the lateral surface thereof;
wherein the first roller comprises a plurality of first cutting elements;
and wherein the cutting unit comprises a plurality of stopping members, each associated to one first cutting element.
